(19) United States
(12) Patent Application Publication
(10) Pub. No.: US 2012/0293312 A1
(43) Pub. Date: Nov. 22, 2012

(54) FORCE FEEDBACK DEVICE AND POSITIONING METHOD OF THE SAME

(76) Inventors: Chien-Chang Huang, Taoyuan County (TW); Shih-Jung Huang, Taoyuan County (TW)

(21) Appl. No.: 13/431,997

(22) Filed: Mar. 28, 2012

(30) Foreign Application Priority Data
May 19, 2011 (TW) 100117706

(51) Int. Cl. G08B 6/00

(52) U.S. Cl. 340/407.2

(57) ABSTRACT

The invention is to provide a force feedback device and a positioning method. The force feedback device includes a microprocessor which controls a motor to rotate at a constant velocity. The motor moves a non-equidistant blocking grating to passes through a detector. The detector detects the passage of the blocking grating to generate an on or off signal. A timer counts the time of the on or off signal to calculate the angle which the blocking grating passes through. The absolute angle of the blocking grating is decided by comparing with an absolute angle stored in a memory to position a joystick.

### BACKGROUND OF THE INVENTION

1. Field of the Invention

The invention relates to a force feedback device, and more particularly, to a force feedback device and a positioning method thereof, which can determine position of a joystick when activating the force feedback device.

2. Description of the Prior Art

A force feedback device integrates stick controllers, buttons, or knobs with different control functions to a joystick. The moving range of the joystick is separated to a plurality of control function areas. Different control function areas are given different force feedback types to indicate a current control function of the joystick, so as to simplify the control method and scheme.

Please refer to FIG. 1. FIG. 1 shows a force feedback device 10 of U.S. Pat. No. 7,490,530. In the force feedback device 10, a joystick 11 controls rotary shafts 12a, 12b in two dimensions simultaneously. A fan-shaped gear portion 13a is integrally formed at one side of the rotary shaft 12a, and a fan-shaped gear portion 13b is integrally formed at one side of the rotary shaft 12b. Each of the rotary shafts 12a, 12b are driven by a motor (not shown), and provided force feedback. In addition, a swing arm 14a is fixed to the other side of the rotary shaft 12a, and a swing arm 14b is fixed to the other side of the rotary shaft 12b. The L-shape blocking portions 15a and 15b of the swing arms 14a and 14b occupy half of detecting areas in which the swing arms 14a and 14b can swing. If the L-shape blocking portions 15a and 15b move to pass through the detector 17a and 17b, the detector 17a and 17b are blocked by the L-shape blocking portions 15a and 15b, so that off signals are output from the detector 17a and 17b. However, if the L-shape blocking portions 15a and 15b move away from the detector 17a and 17b, the detector 17a and 17b are not blocked by the L-shape blocking portions 15a and 15b, and the detector 17a and 17b output on signals.

Since users may incautiously move the joystick 11, and the force feedback device 10 can not determine the position of the joystick 11 when activated, a positioning process is required to be performed. When the force feedback device 10 performs the positioning process, the motors are utilized for driving the fan-shaped gear portion 13a and the fan-shaped gear portion 13b to rotate the rotary shafts 12a, 12b, to make the swing arms 14a and 14b swing, and move the joystick 11 to perform the positioning process. When the L-shape blocking portions 15a and 15b move to pass through or move away from the detector 17a and 17b, the detector 17a and 17b output on/off signals, and the joystick 11 can be determined to be at a center of the swing angle, and the positioning process is completed.

However, the prior art has to let the L-shape blocking portions 15a and 15b move to the center of the swing angle to move to pass through or move away from the detector 17a and 17b and the detector 17a and 17b output on/off signals, so as to complete the positioning process. It requires much more time to complete the positioning process since the L-shape blocking portions 15a and 15b occupy half of detecting areas in which the swing arms 14a and 14b can swing. Moreover, it even requires longer time to complete the positioning process when the motors drive the L-shape blocking portions 15a and 15b at wrong directions. Thus, this conventional force feedback device can not satisfy user's requirement of using right away after powering on the force feedback device since the conventional force feedback device has to wait after being powered on. It is inconvenient to use the conventional force feedback device. Thus, there are problems required to be solved in the positioning scheme and method of the conventional force feedback device.

### SUMMARY OF THE INVENTION

One objective of the present invention is to provide a force feedback device and a positioning method thereof, which comprises a swing arm having non-equidistant blocking grating, and uses a motor to rotate at a constant velocity to count the time of blocking or not blocking the detector, so as to complete positioning fast.

Another objective of the present invention is to provide a force feedback device and a positioning method thereof, which comprises a multi-dimensional swing arm having non-equidistant blocking grating for positioning of a multi-dimensional force feedback device.

To achieve the abovementioned objectives, the force feedback device of the present invention comprises: at least a rotary shaft, having a driving opening positioned in a center of the rotary shaft; a joystick, having an end passing through the driving opening, and movably connected to the force feedback device; a motor, connected to an end of the rotary shaft, for rotating the rotary shaft; a swing arm, connected to another end of the rotary shaft, for rotating with the rotary shaft simultaneously, and having non-equidistant blocking grating; a detector, positioned on a path of the blocking grating, for detecting the non-equidistant blocking grating to generate an on/off signal; a memory device, for storing absolute angle of the blocking grating; and a microprocessor, for controlling rotation of the motor, and measuring time of the on/off signal of the detector via a timer; wherein the microprocessor controls the motor to rotate at a constant velocity forward or backward, to take the blocking grating with different intervals to pass through the detector to generate the on/off signal; the timer counts the time of the on/off signal for the microprocessor to calculate the angle which the blocking grating passes through; and the absolute angle of the blocking grating is decided by comparing with a predetermined absolute angle stored in the memory device, so as to position the joystick.

The positioning method for a force feedback device of the present invention comprises: (1) activating a motor to rotate at a constant velocity to rotate a rotary shaft to make blocking grating pass through a detector at a constant velocity; (2) checking whether the detector generates an on/off signal change; if the detector generates the on/off signal change, go to step (3); otherwise, continue to checking whether the detector generates the on/off signal change; (3) starting time counting; (4) detecting a rotating direction of the motor, and detecting the on/off signal of the detector; (5) checking whether the detector generates the on/off signal change again; if the detector generates the on/off signal change, go to step (6); otherwise, continue to checking whether the detector generates the on/off signal change; (6) stopping time counting; (7) determining a position of a joystick in one dimension according to the detected rotating direction of the motor, the on/off signal of the detector, the time counting, and a stored absolute angle of the blocking grating; and (8) completing positioning the joystick in one dimension.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a force feedback device according to prior art.

FIG. 2 is a diagram of a force feedback device in accordance with a first embodiment of the present invention.

FIG. 3 is a diagram of a swing arm of the present invention.

FIG. 4 is a diagram of a swing arm of the present invention.

FIG. 5 is a diagram of an absolutely position of a blocking grating of the present invention.

FIG. 6 is a diagram of detecting the blocking grating of the present invention.

FIG. 7 is a flowchart of positioning method for a force feedback device in accordance with a first embodiment of the present invention.

FIG. 8 is a diagram of a force feedback device in accordance with a second embodiment of the present invention.

FIG. 9 is a flowchart of positioning method for a force feedback device in accordance with a second embodiment of the present invention.

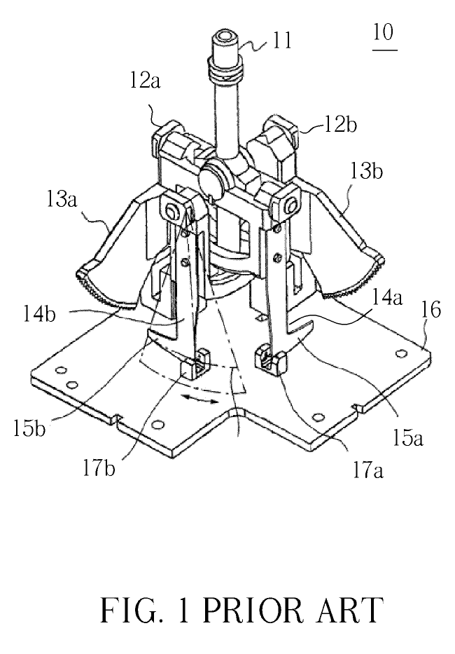

### DETAILED DESCRIPTION

In order to achieve the abovementioned objectives of the present invention, the adopted technical means and effects are described below by illustrating embodiments with drawings.

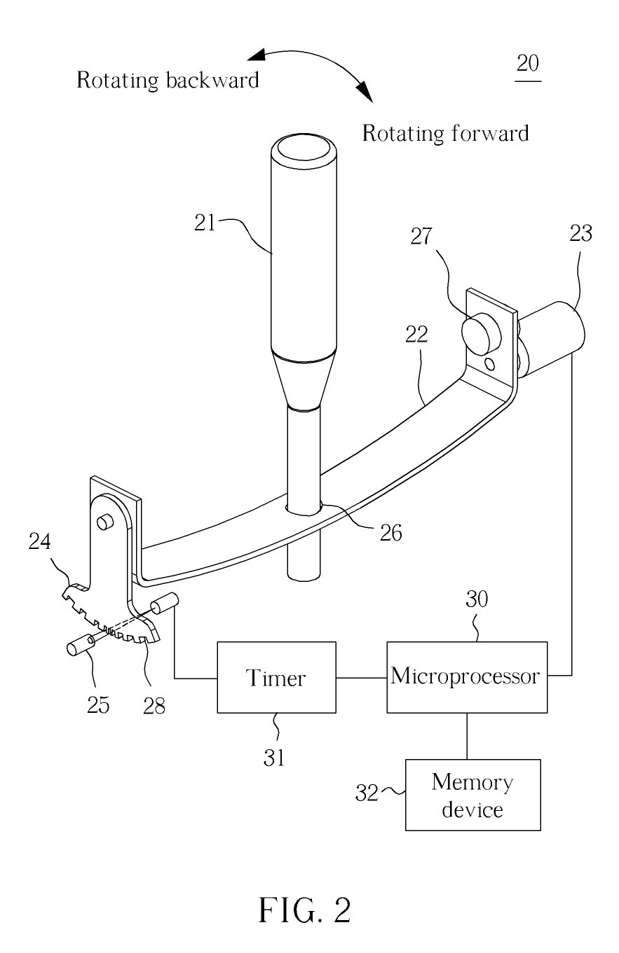

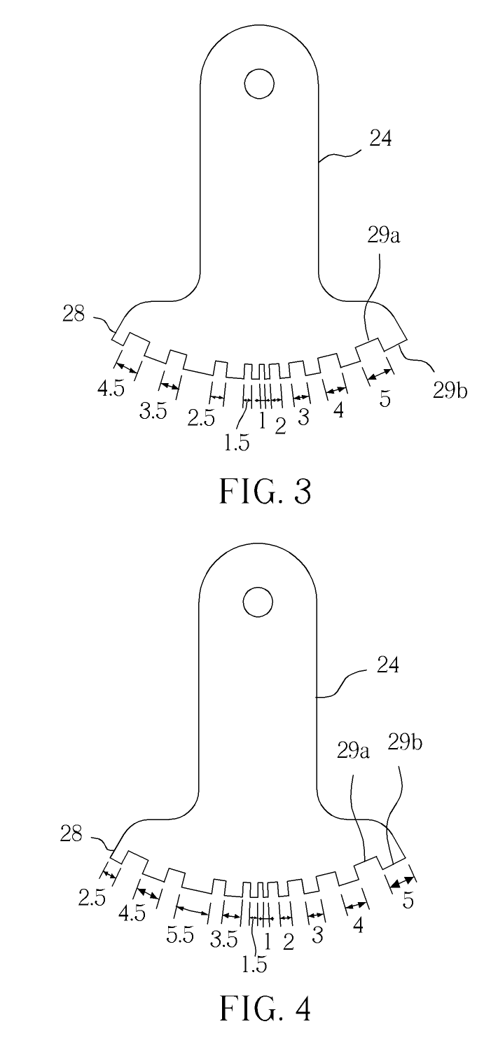

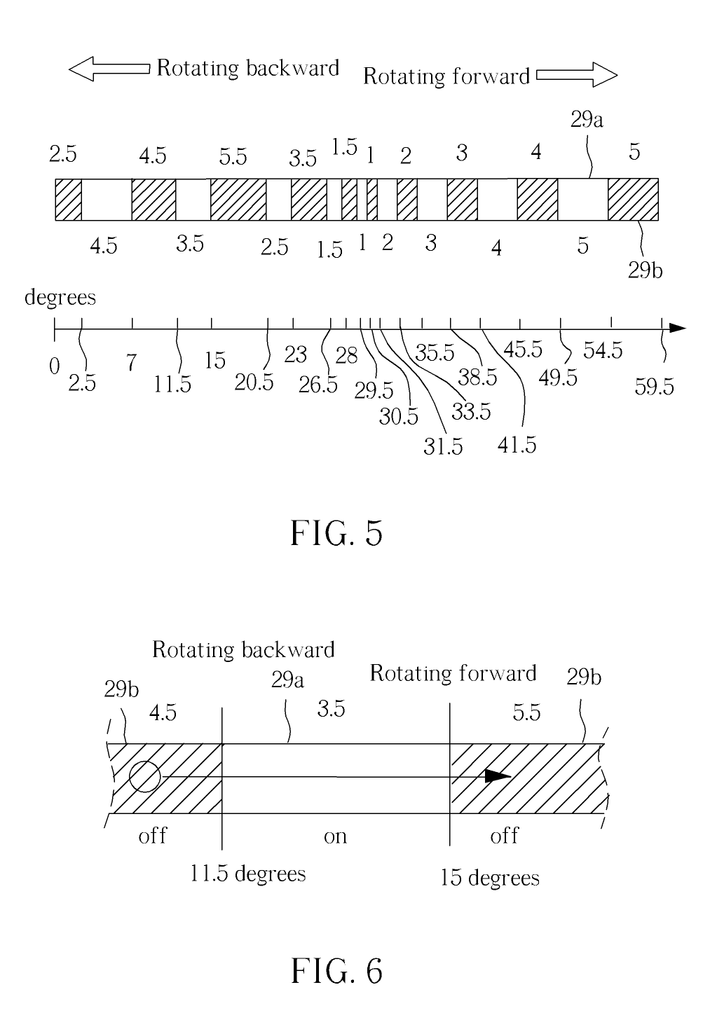

Please refer to FIGS. 2-5. FIG. 2 is a diagram of a force feedback device in accordance with a first embodiment of the present invention. FIGS. 3-4 are diagrams of a swing arm of the present invention. FIG. 5 is a diagram of an absolutely position of a blocking grating of the present invention. The force feedback device 20 of the present invention in FIG. 2 is a one-dimensional force feedback device, comprising: a joystick 21, a rotary shaft 22, a motor 23, a swing arm 24, and a detector 25. An end of the joystick 21 passes through a driving opening 26 positioned in a center of the rotary shaft 22, and the joystick 21 is movably connected to the force feedback device 20. An end of the rotary shaft 22 is connected to the motor 23, and the motor 23 is utilized for rotating the rotary shaft forward or backward in a predetermined angle range. The motor 23 can rotate the rotary shaft 22 via a deceleration gear set 27 to make the rotary shaft 22 rotate at a proper velocity.

The swing arm 24 is connected to another end of the rotary shaft 27, and utilized for rotating with the rotary shaft 27 simultaneously, and the swing arm 24 has a non-equidistant blocking grating 28. The detector 25 is positioned on a path of the blocking grating 28, and utilized for detecting whether the blocking grating 28 is blocked or not to generate an on/off signal. However, please note that the above embodiment is only for an illustrative purpose and is not meant to be a limitation of the present invention. Any senor which is able to detecting whether the blocking grating 28 is blocked or not can be utilized in the present invention. For example, a magnetic senor can be utilized in the present invention. In addition, the force feedback device 20 of the present invention further comprises a microprocessor 30 for controlling and detecting rotation direction of the motor 23, detecting the on/off signal change of the motor 23, and measuring continuing time of the on/off signal of the detector 25 via a timer 31.

In FIG. 3, an end of the swing arm 24 has a plurality of notches 29a and a plurality of protruding parts 29b to form the non-equidistant blocking grating 28, wherein each of the notches 29a has a non-equidistant angle to form a plurality of equidistant and non-equidistant protruding parts 29b, as shown in FIG. 4. At a predetermined basic point, such as a predetermined basic point of 0 degree on a side of the largest swing angle of the swing arm 24, the notches 29a and the protruding parts 29b of the swing arm 24 in FIG. 5 can obtain the absolute angle of two sides of each notch 29a shown in the axis, and the absolute angle of the blocking grating 28 is stored in the memory device 32 of the force feedback device 20.

Please refer to FIG. 2 and FIG. 6 simultaneously. FIG. 6 is a diagram of detecting the blocking grating of the present invention. When the force feedback device 20 performs the positioning process, the microprocessor 30 controls the motor 23 to rotate at a constant velocity, and rotate the rotary shaft 22 via the deceleration gear set 27, and swing the swing arm 24 to make the blocking grating 28 of the swing arm 24 move at a constant velocity in the detector 25. For example, as shown in FIG. 6, assuming that the detector 25 projects a light beam at the 4.5 degrees protruding part 29b of the blocking grating 28 when activated, the detector 25 generates an off signal since the light beam is blocked. When the motor 23 constantly rotates, the light beam will move to the 3.5 degrees notch 29a of the blocking grating 28 along the arrow mark. When the light beam enter to the 3.5 degrees notch 29a from the 4.5 degrees protruding part 29b, the detector 25 generates an on signal since the light beam is not blocked, and an on/off signal change is generated. When the microprocessor 30 detects the on/off signal change of the detector 25, the timer 31 counts the lasting time of the on signal of the detector 25, and rotating direction of the motor 23, such as forward direction, is detected. When the light beam enter to the 5.5 degrees protruding part 29b from the 3.5 degrees notch 29a, the light beam is blocked again, and the microprocessor 30 detects the on/off signal change of the detector 25 again. The microprocessor 30 calculates the angle which the blocking grating 28 passes through by using the time between the two times on/off signal changes and according to the motor rotating at the constant velocity. The 3.5 degrees notch 29a is decided by comparing with an absolute angle of the blocking grating 28 stored in the memory device 32, and a timer end is determined to be a forward side of the 3.5 degrees notch 29a according to forward rotation direction of the motor 23 (i.e. the absolute angle of 15 degrees), so as to position the joystick 21.

Similarly, if the rotation direction of the motor 23 is detected to be backward rotation direction, then timer end is determined to be a backward side of the 3.5 degrees notch 29a (i.e. the absolute angle of 11.5 degrees). If timer 31 counts time for the off signal of the detector 25, the 3.5 degrees protruding part 29b can be decided by comparing with an absolute angle of the blocking grating 28 stored in the memory device 32. Thus, the present invention can complete positioning by only moving a notch or a protruding part of the blocking grating 28 for a small angle.

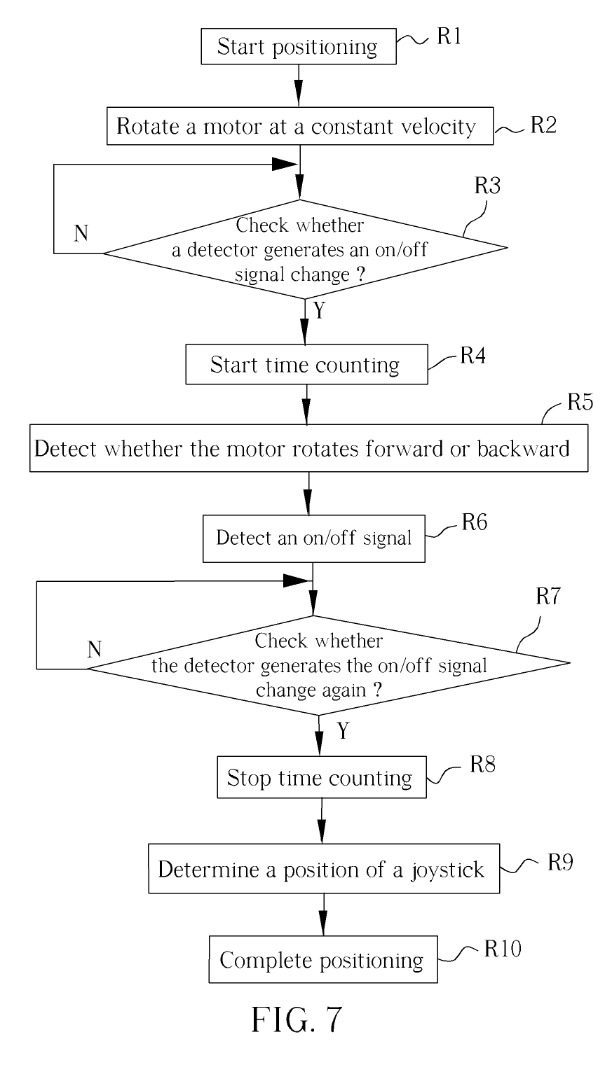

Please refer to FIG. 7. FIG. 7 is a flowchart of positioning method for a force feedback device in accordance with a first embodiment of the present invention. The steps of using a non-equidistant blocking grating to position in the first embodiment of the present invention are illustrated as follows. Step R1: The force feedback device starts positioning. Step R2: Activate a motor to rotate at a constant velocity to make a blocking grating move at a constant velocity in the sensor. Step R3: Check whether a detector generates an on/off signal change. If the detector generates an on/off signal change, go to Step R4; otherwise, continue to check whether the detector generates an on/off signal change. Step R4: Start time counting. Step R5: Detect a rotation direction of the motor. Step R6: Detect an on/off signal of the detector. Step R7: Check whether the detector generates the on/off signal change again. If the detector generates an on/off signal change, go to Step R8; otherwise, continue to check whether the detector generates an on/off signal change. Step R8: Stop time counting. Step R9: Determine a position of a joystick according to the rotating direction of the motor detected in Step R5, the on/off signal of the detector detected in Step R6, the time counting, and a stored absolute angle of the blocking grating. Step R10: Complete positioning.

Thus, the force feedback device and the positioning method thereof in the first embodiment of the present invention can fast complete positioning of the force feedback device by setting the non-equidistant blocking grating in the swing arm and rotating the motor at the constant velocity to pass through the sensor, and only swinging for a small angle to generate blocking/un-blocking time for the sensor.

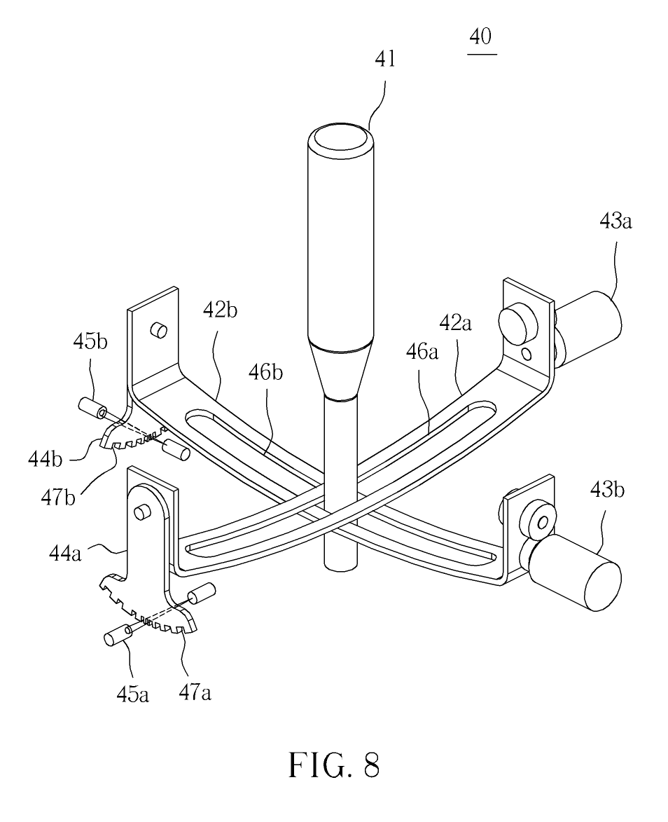

Please refer to FIG. 8. FIG. 8 is a diagram of a force feedback device 40 in accordance with a second embodiment of the present invention. The force feedback device 40 in the second embodiment of the present invention also comprises the microprocessor, the timer, and the memory device of the force feedback device in the first embodiment of the present invention. The difference between the two embodiments is that the force feedback device 40 in the second embodiment expands the one-dimensional force feedback device in the first embodiment to be a two-dimensional force feedback device. Thus, besides the force feedback device 40 in the second embodiment comprises a joystick 41, the positioning structure of each dimension in the force feedback device 40 comprising rotary shafts 42a, 42b, motors 43a, 43b, swing arms 44a, 44b, and detectors 45a, 45b, are similar with the positioning structure of the force feedback device in the first embodiment. The rotary shafts 42a, 42b comprises a strip shaped driving openings 46a, 46b, respectively. The driving openings 46a, 46b are cross positioned, and the joystick 41 passes through the two cross positioned driving openings 46a, 46b, to drive the two rotary shafts 42a, 42b, respectively. The non-equidistant blocking gratings 47a, 47b of the swing arms 44a, 44b swing in the detectors 45a, 45b, to generate the on/off signal change of un-blocking/blocking the detectors 45a, 45b, so as to complete positioning of the force feedback device 40.

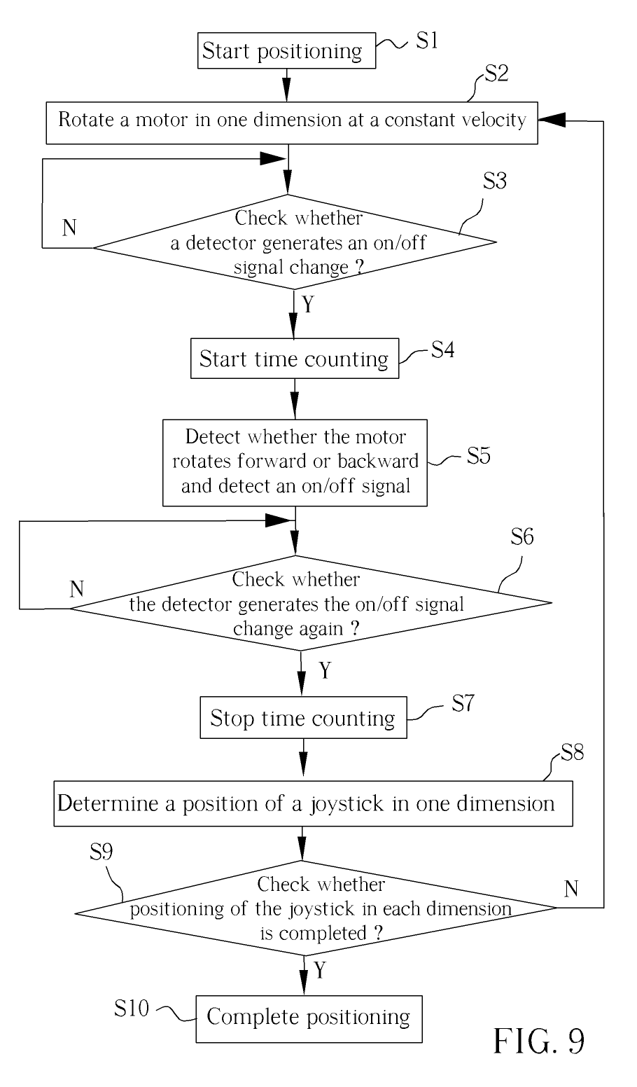

Please refer to FIG. 9. FIG. 9 is a flowchart of positioning method for a force feedback device in accordance with a second embodiment of the present invention. The steps of the method for the force feedback device in the second embodiment of the present invention are illustrated as follows. Step S1: The force feedback device starts positioning. Step S2: Activate a motor in one dimension to rotate at a constant velocity to make a blocking grating move at a constant velocity in the sensor. Step S3: Check whether a detector generates an on/off signal change. If the detector generates an on/off signal change, go to Step S4; otherwise, continue to check whether the detector generates an on/off signal change. Step S4: Start time counting. Step S5: Detect a rotation direction of the motor and detect an on/off signal. Step S6: Check whether the detector generates the on/off signal change again. If the detector generates an on/off signal change, go to Step S7; otherwise, continue to check whether the detector generates an on/off signal change. Step S7: Stop time counting. Step S8: Determine a position of a joystick in one dimension according to the rotating direction of the motor detected in Step S5, the on/off signal of the detector detected in Step S5, the time counting, and a stored absolute angle of the blocking grating. Step S9: Check whether positioning of the joystick in each dimension is completed. If positioning of the joystick in each dimension is not completed, go back to Step S2 to activate another motor in another dimension to position the joystick in another dimension; if positioning of the joystick in each dimension is completed, go to step S10. Step S10: Complete positioning.

Thus, the force feedback device and the positioning method thereof in the second embodiment of the present invention can set the non-equidistant blocking gratings in the swing arms of a multi-dimensional force feedback device to complete positioning of the force feedback device of at least one dimension.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A force feedback device, comprising:
at least a rotary shaft, having a driving opening positioned in a center of the rotary shaft;
a joystick, having an end passing through the driving opening, and movably connected to the force feedback device;
a motor, connected to an end of the rotary shaft, for rotating the rotary shaft;
a swing arm, connected to another end of the rotary shaft, for rotating with the rotary shaft simultaneously, and having a non-equidistant blocking grating;
a detector, positioned on a path of the blocking grating, for detecting the non-equidistant blocking grating to generate an on/off signal;
a memory device, for storing absolute angle of the blocking grating; and
a microprocessor, for controlling rotation of the motor, and measuring time of the on/off signal of the detector via a timer;
wherein the microprocessor controls the motor to rotate at a constant velocity forward or backward, to take the blocking grating with different intervals to pass through the detector to generate the on/off signal; the timer counts the time of the on/off signal for the microprocessor to calculate the angle which the blocking grating passes through; and the absolute angle of the blocking grating is decided by comparing with a predetermined absolute angle stored in the memory device, so as to position the joystick.

2. The force feedback device of claim 1, wherein an end of the swing arm has a plurality of notches and a plurality of protruding parts to form the non-equidistant blocking grating.

3. The force feedback device of claim 2, wherein each of the notches has a non-equidistant angle to form a plurality of equidistant and non-equidistant protruding parts.

4. The force feedback device of claim 3, wherein the detector is a light detector.

5. The force feedback device of claim 4, wherein the notches does not block the detector, so as to generate the on signal, and the protruding parts block the detector, so as to generate the off signal; whether the notch or the protruding part passes through the detector is determined according to the on/off signal, and whether forward side position or backward side position of the notch or the protruding part to be a timer end is determined according to forward or backward rotation of the motor.

6. The force feedback device of claim 1, wherein a basic point of the absolute angle is positioned on a side of the largest swing angle of the swing arm.

7. The force feedback device of claim 1, wherein microprocessor calculates the angle which the blocking grating passes through according to time between the on signal and the off signal change.

8. The force feedback device of claim 1, further comprising two rotary shafts with two dimensions and two cross positioned driving openings, and the joystick passes through the two cross positioned driving openings, to drive the two rotary shafts, respectively.

9. A positioning method for a force feedback device, comprising:
(1) activating a motor to rotate at a constant velocity to rotate a rotary shaft to make blocking grating pass through a detector at a constant velocity;
(2) checking whether the detector generates an on/off signal change; if the detector generates the on/off signal change, go to step (3); otherwise, continue to checking whether the detector generates the on/off signal change;
(3) starting time counting;
(4) detecting a rotating direction of the motor, and detecting the on/off signal of the detector;
(5) checking whether the detector generates the on/off signal change again; if the detector generates the on/off signal change, go to step (6); otherwise, continue to checking whether the detector generates the on/off signal change;
(6) stopping time counting;
(7) determining a position of a joystick in one dimension according to the detected rotating direction of the motor, the on/off signal of the detector, the time counting, and a stored absolute angle of the blocking grating; and
(8) completing positioning the joystick in one dimension.

10. The method of claim 9, after determining the position of the joystick in one dimension in step (7), the method further comprising a step (7A) of checking whether completing positioning the joystick in each dimension; if no, go back to step (1) to activate another motor to position the joystick in another dimension; if yes, go to step (8).
